(19) United States
(12) Patent Application Publication
(10) Pub. No.: US 2019/0235196 A1
(43) Pub. Date: Aug. 1, 2019

(54) LENS SYSTEM FOR HEAD-UP DISPLAY

(71) Applicant: SEKONIX CO., LTD., Dongducheon-si (KR)

(72) Inventors: Seung Ki Hong, Suwon-si (KR); Dong Guen Kim, Suwon-si (KR); Se Young Nam, Seongnam-si (KR)

(73) Assignee: SEKONIX CO., LTD., Dongducheon-si (KR)

(21) Appl. No.: 16/311,394

(22) PCT Filed: May 29, 2017
(86) PCT No.: PCT/KR2017/005568

§ 371 Date: Dec. 19, 2018

(30) Foreign Application Priority Data
Sep. 26, 2016 (KR) 10-2016-0123282

(51) Int. Cl. G02B 7/02; G02B 9/64; G02B 27/01

(52) U.S. Cl. CPC G02B 7/028; B60K 35/00; G02B 27/0101; G02B 9/64

(57) ABSTRACT

The present invention relates to a lens system for a head-up display. The technical gist of the present invention is to provide a lens system for a head-up display, comprising: a first group of lenses positioned toward a screen with reference to a diaphragm; and a second group of lenses positioned toward an image element, wherein each lens is combined/arranged such that the DN/DT (abs.) (temperature coefficients of refractive index (10⁻⁶/° C. at 632.8 nm)) value of a lens that satisfies |P|>=40 (P is refractive power of each lens), among the plurality of lenses constituting the first and second groups of lenses, has a positive number value or a negative number value according to the refractive power, and the lens system accordingly has thermal compensation characteristics by controlling the amount of change in the focal distance of each lens. Accordingly, the present invention advantageously provides a lens system for a head-up display wherein the DN/DT value, which follows the refractive power of each lens, is arranged/designed appropriately such that temperature-based thermal compensation characteristics are satisfied by controlling the amount of change in the focal distance of each lens.

### TECHNICAL FIELD

Example embodiments relate to a lens system for a head-up display, and more particularly, a lens system for a head-up display including lenses arranged such that DN/DT (abs.) (temperature coefficients of refractive index [10-6/° C. at 632.8 nm]) values are desirably arranged based on a refractive power of each of the lenses and a variation in focal length of each of the lenses is controlled, thereby satisfying a temperature-based thermal compensation characteristic.

### BACKGROUND ART

A small camera module has been widely used by recent demands for miniaturization and high resolution of a device such as a portable terminal, a drone, an action-cam, a head-mounted display, a head-up display, and the like.

Among these devices, a head-up display is mainly used to provide a user with device information and environment information about surroundings of the user within a range not deviating from a main visual field of the user.

For example, a head-up display device for a vehicle may be used to effectively provide a driver with travel information and environment information about situations around the vehicle, while ensuring safety of the driver. This head-up display device may provide such information on a front side of the driver, for example, a windshield of the vehicle, while the vehicle is travelling. In general, the head-up display device may allow an image from a projector to be projected as a virtual image onto the windshield of the vehicle using a head-up display mirror.

In addition, there is a growing demand for easier installation of such a head-up display device in a vehicle, and miniaturization and high resolution of the head-up display, in order to improve its performance. Thus, a projector for the head-up display device may be equipped with a lens system including five or more lenses to achieve the high resolution.

However, this lens system may be affected by heat generated from internal elements as the head-up display device becomes more compact in size. For example, when an internal temperature of the vehicle increases or a temperature of the internal elements increases, a change in refractive power of the lenses may become more significant and an image may not be desirably projected as designed, and accordingly a distorted image may be finally produced.

In general, a desirable effective focal length may be obtained at a room temperature of 20° C. However, when the temperature increases, an effective focal length of each lens may change, or the internal elements included in the lens system may change in positions and shapes due to the increase in temperature. Thus, a lens in a lens array of the lens system may deviate from a set position of the lens, and thus the internal temperature may increase as a period of time for which the product is used increases. Thus, a designed effective focal length may change, and thus a desired image quality may not be achieved. That is, a thermal compensation characteristic may not be satisfied.

Related existing technology may design a deviation in effective focal length of a first group of lenses arranged towards a screen from a diaphragm (or, stop) of a compact camera system, and a deviation in effective focal length of a second group of lenses arranged towards an image element from the diaphragm to be all inclined to a positive direction, and thus a more distorted image may be generated and also some advantageous properties such as high resolution, high performance, and miniaturization may not be readily achieved.

### DISCLOSURE OF INVENTION

### Technical Goals

Example embodiments provide a lens system for a head-up display that may satisfy a temperature-based thermal compensation characteristic, and include lenses arranged such that DN/DT (abs.) (temperature coefficients of refractive index [10-6/° C. at 632.8 nm]) values are desirably arranged based on a refractive power of each of the lenses and a variation in focal length of each of the lenses is controlled.

### Technical Solutions

According to an example embodiment, there is provided a lens system for a head-up display, the lens system including a first group of lenses arranged towards a screen from a diaphragm, and a second group of lenses arranged towards an image element. Each of the lenses included in the first group and the second group may be arranged such that a lens among the lenses that satisfies |P|=40, wherein P denotes a refractive power of each of the lenses, has a positive or negative DN/DT (abs.) (temperature coefficients of refractive index [10⁻⁶/° C. at 632.8 nm]) value based on the refractive power, and the lens system may be configured to control a variation in focal length of each of the lenses to have a thermal compensation characteristic.

A first lens, a second lens, a third lens, and a fourth lens of the first group may be arranged from the screen along an optical axis. A fifth lens, a sixth lens, a seventh lens, and an eighth lens of the second group may be arranged from the screen along the optical axis. The third lens, the fifth lens, the seventh lens, and the eighth lens may have a positive refractive power. The fifth lens, the seventh lens, and the eighth lens may have a refractive power greater than a refractive power of the third lens, and the fifth lens, the seventh lens, and the eighth lens may have a negative DN/DT (abs.) value.

In addition, the fifth lens, the seventh lens, and the eighth lens may have a negative DN/DT (abs.) value in a temperature range from 60° C. to 80° C.

In a temperature range from −40° C. to −20° C., the fifth lens may be selected from a group of materials having a DN/DT (abs.) value of −7.7 to −7.1, the seventh lens may be selected from a group of materials having a DN/DT (abs.) value of −7.7 to −7.1, and the eighth lens may be selected from a group of materials having a DN/DT (abs.) value of −4.9 to −4.3. Alternatively, in the temperature range from 60° C. to 80° C., the fifth lens may be selected from a group of materials having a DN/DT (abs.) value of −7.3 to −6.7, the seventh lens may be selected from a group of materials having a DN/DT (abs.) value of −7.3 to −6.7, and the eighth lens may be selected from a group of materials having a DN/DT (abs.) value of −3.9 to −3.3.

Each of the fifth lens, the seventh lens, and the eighth lens may satisfy 40.00<P<70.00, wherein P denotes a refractive power.

The lens system may be configured to satisfy −3.5<f1/f2<0, wherein f1 denotes an effective focal length of the first group, and f2 denotes an effective focal length of the second group.

The lens system may be configured to satisfy f2/F>1.1, wherein f2 denotes the effective focal length of the second group, and F denotes an overall effective focal length of the lens system.

### Advantageous Effects

According to example embodiments described herein, there is provided a lens system for a head-up display that may satisfy a temperature-based thermal compensation characteristic by arranging lenses thereof such that DN/DT (abs.) (temperature coefficients of refractive index [10⁻⁶/° C. at 632.8 nm]) values are desirably arranged based on a refractive power of each of the lenses, and controlling a variation in focal length of each of the lenses.

According to example embodiments described herein, there is provided a high-resolution and high-performance lens system for a head-up display that may satisfy a thermal compensation characteristic and thus provide a stable image despite a change in temperature by setting a DN/DT value for a lens having a relatively high refractive power.

For example, the high-resolution and high-performance lens system may be designed to include therein a lens array including a total of eight lenses, and set a DN/DT value for a lens having a relatively high refractive power in order to satisfy the thermal compensation characteristic and provide a stable image despite a change in temperature.

### BRIEF DESCRIPTION OF DRAWINGS

FIG. 1 is a diagram illustrating an example of a lens system for a head-up display according to an example embodiment.

FIG. 2 is a diagram illustrating another example of a lens system for a head-up display according to an example embodiment.

FIG. 3 illustrates modulation transfer function (MTF) graphs obtained from the example of FIG. 1.

### BEST MODE FOR CARRYING OUT THE INVENTION

Example embodiments of the present disclosure to be described hereinafter relate to a lens system for a head-up display. The lens system for a head-up display will be hereinafter referred to as a head-up display lens system, or simply as a lens system. The lens system may satisfy a temperature-based thermal compensation characteristic by arranging lenses such that DN/DT (abs.) (temperature coefficients of refractive index [10⁻⁶/° C. at 632.8 nm]) values are desirably arranged based on a refractive power of each of the lenses, and controlling a variation in focal length of each of the lenses.

The example embodiments relate, more particularly, to a high-resolution and high-performance head-up display lens system that may satisfy a thermal compensation characteristic and provide a stable image despite a change in temperature, by setting a DN/DT value for a lens having a relatively high refractive power.

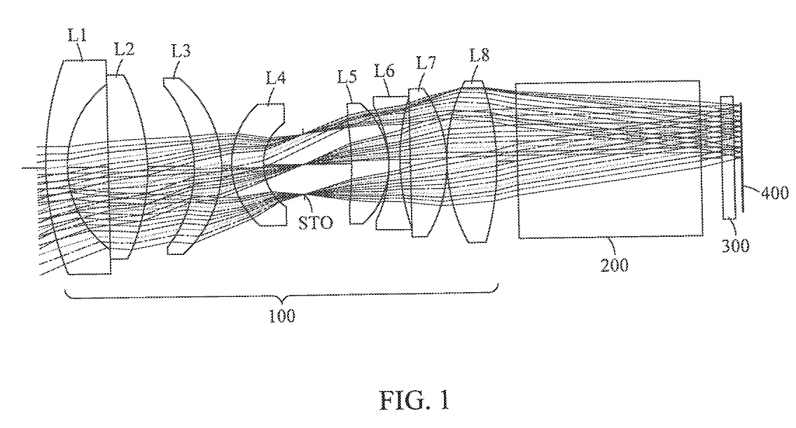

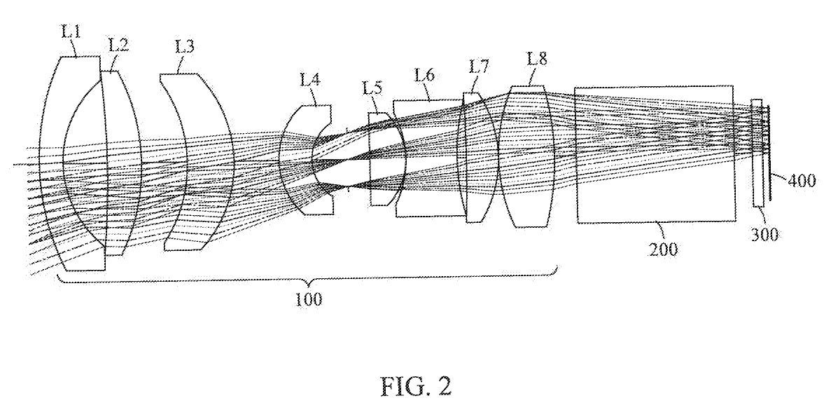

Hereinafter, the example embodiments will be described in detail with reference to the accompanying drawings. FIGS. 1 and 2 illustrate examples of a head-up display lens system according to an example embodiment.

According to an example embodiment, a head-up display lens system includes a first group of lenses arranged towards a screen from a diaphragm and a second group of lenses arranged towards an image element. The lenses included in the first group and the second group may be arranged such that a DN/DT (abs.) value of a lens among the lenses satisfying |P|≥40 (where, P denotes a refractive power of each lens) is a positive value or a negative value based on the refractive power, and thus the lens system may control a variation in focal length of each of the lenses to have a thermal compensation characteristic.

The lens system may control a variation in focal length of each lens based on a temperature by appropriately adjusting a DN/DT value of a lens among the lenses included in the first group and the second group having a relatively high refractive power, or desirably a lens satisfying |P|≥40 (where, P denotes a refractive power of each lens).

Herein, it is desirable to allow a lens having a positive refractive power to have a negative DN/DT value, and a lens having a negative refractive power to have a positive DN/DT value.

Thus, by disposing a material having a negative DN/DT value or a positive DN/DT value in an appropriate position in the head-up display lens system based on an intrinsic characteristic of a glass material of which a refractive index changes depending on a temperature, it is possible to compensate for a resolution degradation based on a change in focal length occurring when a set position of a lens changes as a refractive index changes by heat.

That is, by restricting a refractive power of a lens to a desired value when designing the lens system, it is possible to control a variation in focal length by selecting a material for a lens based on an intrinsic property of a lens that DN/DT value differs for each material.

The head-up display lens system having such a characteristic or property may include a plurality of lenses. For example, the lens system may include a first group of lenses arranged towards a screen from a diaphragm, and a second group of lenses arranged towards an image element. In this example, a total number of lenses of a lens array included in the lens system may be selected from five, six, seven, eight, and the like based on a purpose of use and resolution.

An example of the head-up display lens system using eight lenses will be described hereinafter.

As illustrated, the head-up display lens system includes a first group of lenses arranged towards a screen from a diaphragm STO, and a second group of lenses arranged towards an image element 400. The first group includes a first lens L1, a second lens L2, a third lens L3, and a fourth lens L4, which are arranged from the screen along an optical axis. The second group includes a fifth lens L5, a six lens L6, a seventh lens L7, and an eighth lens L8, which are arranged from the screen along the optical axis. The first lens L1 has a negative refractive power, the second lens L2 has a positive refractive power, the third lens L3 has a positive refractive power, the fourth lens L4 has a negative refractive power, the fifth lens L5 has a positive refractive power, the sixth lens L6 has a negative refractive power, the seventh lens L7 has a positive refractive power, and the eighth lens L8 has a positive refractive power. Among these, the fifth lens L5, the seventh lens L7, and the eighth lens L8 have respective refractive power values greater than respective refractive power values of the second lens L2 and the third lens L3. In addition, the fifth lens L5, the seventh lens L7, and the eighth lens L8 have negative DN/DT (abs.) values.

As illustrated in FIGS. 1 and 2, the head-up display lens system includes the screen (not shown) at a leftmost position, a lens array 100, a total internal reflection prism 200, a cover glass 300, and the image element 400.

The lens array 100 included in the head-up display lens system may enable a high performance suitable for a high-resolution lens system by allowing positive and negative refractive powers of the lenses therein to be uniformly distributed.

For example, as illustrated, the first group includes the first lens L1, the second lens L2, the third lens L3, and the fourth lens L4, which are arranged towards the screen from the diaphragm STO. The second group includes the fifth lens L5, the sixth lens L6, the seventh lens L7, and the eighth lens L8, which are arranged towards the image element 400.

The first lens L of the first group is formed in a meniscus shape and has a negative refractive power. The second lens L2 of the first group is formed to be convex towards the image element 400 and has a positive refractive power. The third lens L3 of the first group is formed in a meniscus shape and has a positive refractive power. The fourth lens L4 of the first group is formed in a meniscus shape. As described above, the shapes and refractive powers of the lenses are appropriately distributed to construct the lens system to be compact in size, and to compensate for a distortion and enable a high performance and high resolution.

The fifth lens L5 of the second group is formed in a meniscus shape and has a positive refractive power. The sixth lens L6 of the second group is formed to be concave towards the image element 400 or the screen, and has a negative refractive power. The seventh lens L7 of the second group is formed to be convex towards the image element 400 and has a positive refractive power. The eighth lens L8 is formed to be convex towards the screen and has a positive refractive power. As described above, the shapes and refractive powers of the lenses are appropriately distributed to allow a ray of light passing through the diaphragm STO to reach the image element 400 and enable the lens system to be compact in size and have a high resolution.

The first through eighth lenses, L1 through L8 as illustrated, may be formed of a glass material such that a change in characteristic or property occurring due to a change in temperature is reduced, or alternatively, minimized, and a change in optical performance of a lens occurring due to a thermal change is thus reduced, or alternatively, minimized.

In addition, the fifth lens L5, the seventh lens L7, and the eighth lens L8 of the second group may be formed of a material selected from a group of materials having a positive focal length and a refractive power relatively greater than that of the second lens L2 and the third lens L3 which have different positive refractive powers. In detail, the fifth lens L5, the seventh lens L7, and the eighth lens L8 of the second group have a refractive power satisfying 40.00<P<70.00, where P denotes a refractive power of each lens.

In addition, the fifth lens L5, the seventh lens L7, and the eighth lens L8 of the second group may be formed of a material selected from a group of materials having a negative DN/DT (abs.) value at a high temperature, for example, in a temperature range from 60° C. to 80° C. The material may be desirably selected from the materials having a DN/DT (abs.) value in a range from −7.8 and −3.3.

In a temperature range from −40° C. to −20° C., the first lens L1 may be desirably selected from materials having a DN/DT (abs.) value of 0.3 to 1.0, the second lens L2 may be desirably selected from materials having a DN/DT (abs.) value of −1.6 to −1.0, the third lens L3 may be desirably selected from materials having a DN/DT (abs.) value of 0.1 to 0.5, the fourth lens L4 may be desirably selected from materials having a DN/DT (abs.) value of −1.4 to −0.8, the fifth lens L5 may be desirably selected from materials having a DN/DT (abs.) value of −7.7 to −7.1, the sixth lens L6 may be desirably selected from materials having a DN/DT (abs.) value of −1.2 to −0.6, the seventh lens L7 may be desirably selected from materials having a DN/DT (abs.) value of −7.7 to −7.1, and the eighth lens L8 may be desirably selected from materials having a DN/DT (abs.) value of −4.9 to −4.3.

In a temperature range from 60° C. to 80° C., the first lens L1 may be desirably selected from materials having a DN/DT (abs.) value of 1.7 to 2.3, the second lens L2 may be desirably selected from materials having a DN/DT (abs.) value of 0.2 to 0.8, the third lens L3 may be desirably selected from materials having a DN/DT (abs.) value of 1.4 to 2.0, the fourth lens L4 may be desirably selected from materials having a DN/DT (abs.) value of 0.4 to 1.0, the fifth lens L5 may be desirably selected from materials having a DN/DT (abs.) value of −7.3 to −6.7, the sixth lens L6 may be desirably selected from materials having a DN/DT (abs.) value of 0.5 to 1.1, the seventh lens L7 may be desirably selected from materials having a DN/DT (abs.) value of −7.3 to −6.7, and the eighth lens L8 may be desirably selected from materials having a DN/DT (abs.) value of −3.9 to −3.3.

In general, a glass material may have a refractive index that increases finely as a temperature increases, and most lenses may have a positive DN/DT value. According to an example embodiment, the lens array 100 may be formed by verifying a refractive power of each lens and selecting a material having a negative DN/DT value at a high temperature, for example, 60° C. to 80° C., as a material for a lens having a relatively great refractive power, for example, the fifth lens L5, the seventh lens L7, and the eighth lens L8, among lenses having a positive focal length.

This is based on a characteristic of a lens that a focal length is forced to change by heat, and the change in focal length by a change in length of the lens at a high temperature is inversely compensated for.

Such a thermal compensation characteristic may not be greatly dependent on a length and a thickness of a lens, and be determined by, for example, a DN/DT value of a material of a lens, a refractive power of the lens, a negative/positive compensation for a refractive power of each group of lenses, and the like.

Thus, by restricting a refractive power of a lens to a desired value while designing the lens system and selecting a lens based on an intrinsic characteristic of a lens that a magnitude of DN/DT value differs from each material, it is thus possible to control a variation in focal length.

In addition, the head-up display lens system may satisfy −3.5<f1/f2<0, where f1 denotes an effective focal length of the first group and f2 denotes an effective focal length of the second group.

Thus, by setting the effective focal length of the second group with respect to the effective focal length of the first group, it is possible to adjust a size of the lens system based on a ratio of the respective effective focal lengths, and reduce the size of the lens system when the respective effective focal lengths of the groups are similar.

In addition, the head-up display lens system may satisfy f2/F>1.1, where f2 denotes the effective focal length of the second group and F denotes an overall effective focal length of the lens system.

Thus, by setting the effective focal length of the second group with respect to the overall effective focal length of the lens system, and setting an overall focal length of the lens system to be shorter than a focal length of the second group, it is possible to construct the head-up display lens system to be smaller in size.

Further, the head-up display lens system may satisfy 0.5<t1/t2<1.5, where t1 denotes a distance from an object surface of the first lens L1 to the diaphragm STO, and t2 denotes a distance from the diaphragm STO) to a top surface.

A length, or a distance, from the diaphragm STO to the image element 400 does not greatly differ from a length, or a distance, from the screen of the first lens L1 to the diaphragm STO, and thus a distortion of the lens system may be compensated for as the distances of t1 and t2 are equal.

Further, the head-up display lens system may satisfy E6/T6<3.0 in which E6 denotes a thickness of a portion on which an outermost ray of light of the second lens L2 is incident and T6 denotes a thickness of a center of the sixth lens L6.

This defines a thickness of an edge, or an edge thickness, and a thickness of the center, or a center thickness, of the sixth lens L6, and it is thus possible to reduce or equalize sensitivities when manufacturing the lenses, and improve a tolerance and performance.

The first through eighth lenses, L1 through L8 as illustrated, of the head-up display lens system may be spherical lenses.

As described above, the head-up display lens system provided herein may be designed to have a high resolution and a high performance by setting a negative DN/DT value for a lens having a high refractive power, or a positive refractive power, among the first through eighth lenses L1 through L8, and may thus satisfy a thermal compensation characteristic and provide a stable image despite a change in temperature.

Hereinafter, example embodiments will be described in detail.

FIGS. 1 and 2 illustrate examples of a head-up display lens system according to an example embodiment. FIG. 2 illustrates a lens system of which an overall length and an overall thickness are set to be different from those of the lens system illustrated in FIG. 2.

As illustrated, the head-up display lens system includes a lens array 100 in which a first lens L1, a second lens L2, a third lens L3, a fourth lens L4, a diaphragm STO, a fifth lens L5, a sixth lens L6, a seventh lens L7, and an eighth lens L8 are arranged in sequential order from a screen along an optical axis, and a total internal reflection prism 200, a cover glass 300, and an image element 400, which are arranged in sequential order.

Table 1 below indicates a refractive power of each of the lenses in the lens array 100 illustrated in FIG. 1.

TABLE 1

| Lens number | Refractive power |
|---|---|
| L1 | −45.53 D |
| L2 | 36.38 D |
| L3 | 11.37 D |
| L4 | −32.42 D |
| L5 | 66.86 D |
| L6 | −89.36 D |
| L7 | 44.36 D |
| L8 | 53.13 D |

Individually, the first lens L1 is formed in a meniscus shape, the second lens L2 is formed to be convex towards the image element 400, the third lens L3 is formed in a meniscus shape, the fourth lens L4 is formed in a meniscus shape, the fifth lens L5 is formed in a meniscus shape, the sixth lens L6 is formed to be concave towards the image element 400 and the screen, the seventh lens L7 is formed to be convex towards the image element 400, and the eighth lens L8 is formed to be convex towards the screen.

Table 2 below indicates a material of each of the lenses, and all the lenses L1 through L8 may be formed of a glass material under respective trade names of HOYA.

TABLE 2

| Lens number | Material |
|---|---|
| L1 | LAC10_HOYA |
| L2 | EFD1_HOYA |
| L3 | BACD4_HOYA |
| L4 | EFD4_HOYA |
| L5 | FCD515_HOYA |
| L6 | EF1_HOYA |
| L7 | FCD515_HOYA |
| L8 | PCD4_HOYA |

Table 3 below indicates a DN/DT value of each of the lenses at a low temperature and at a high temperature. The low temperature is in a range from −40° C. to −20° C., and the high temperature is in a range from 60° C. to 80° C.

TABLE 3

| Lens | DN/DT | DN/DT |
|---|---|---|
| number | (−40/−20) | (+60/+80) |
| L1 | 0.7 | 2.0 |
| L2 | −1.3 | 0.5 |
| L3 | 0.2 | 1.7 |
| L4 | −1.1 | 0.7 |
| L5 | −7.4 | −7.0 |
| L6 | −0.9 | 0.8 |
| L7 | −7.4 | −7.0 |
| L8 | −4.6 | −3.6 |

Table 4 below indicates an effective focal length of each of the lenses, an overall effective focal length F of the lens array 100, and respective effective focal lengths of the first group and the second group.

TABLE 4

| Lens number | Focal length | Group focal length | Overall focal length |
|---|---|---|---|
| L1 | −21.961709 | First group | (L1-L8) |
| L2 | 27.487787 | (L1-L4) | 10.5812 |
| L3 | 87.937213 | −39.0705 | |
| L4 | −30.849654 | | |
| L5 | 14.95554 | Second group | |
| L6 | −11.188767 | (L5-L8) | |
| L7 | 22.545072 | 12.3707 | |
| L8 | 18.820025 | | |

As indicated in Table 4 above, an effective focal length of the first group (L1-L4) is −39.0705 mm and an effective focal length of the second group (L5-L8) is 12.3707 mmg. Thus, by using a material having a negative DN/DT value for a lens, for example, the fifth lens L5, the seventh lens L7, and the eighth lens L8, among the lenses of the second group having a relatively short effective focal length, it is possible to form the lens array 100 such that a variation in refractive index of a lens at a high temperature may be reduced and an overall absolute DN/DT value of the first through eighth lenses L through L8 may be reduced, thereby reducing, or alternatively, minimizing a change in optical performance occurring by heat.

That is, lenses having a negative DN/DT value in a high temperature range are concentrated in the second group, and the effective focal length of the first group is a negative value and the effective focal length of the second group is a positive value. Thus, a temperature-based compensation relationship may be established and a variation in overall effective focal length may be reduced, and it is thus possible to provide a stable image despite a change in temperature.

As described above, a refractive power of each lens may be verified, and a material having a negative DN/DT value at a high temperature may be selected for a lens having a positive focal length and a relatively great refractive power, for example, the fifth lens L5, the seventh lens L7, and the eighth lens LB. This is to satisfy a thermal compensation characteristic to inversely compensate for a change in focal length occurring due to a change in length of a lens at a high temperature.

Such a thermal compensation characteristic may not be greatly dependent on a length and a thickness of a lens, but be determined by, a DN/DT value of a material of a lens, a refractive power of the lens, a positive and negative compensation for refractive power between lens groups. Thus, a material may be selected by specifying a material and a refractive power of a lens such that the lens system may have the thermal compensation characteristic.

Thus, by restricting a refractive power of a lens to a desired value when designing the lens system, and selecting a lens based on a fact that a DN/DT value, which is an intrinsic property of a lens, differs from each material, it is possible to control a variation in focal length of the first group of lenses and the second group of lenses and design the lens system to have a thermal compensation characteristic.

A distance from a surface of the first lens L1 facing the screen to the diaphragm STO is 24 mm. A distance from the diaphragm STO to a surface of the eighth lens L8 facing the image element 400 is 42 mm. A distance from the diaphragm STO to the image element 400 is 40.8396 mm.

Table 5 below indicates a center thickness of each lens, an edge thickness of each lens, which is a thickness of a portion on which an outermost ray of light is incident, and a deviation between the thicknesses.

TABLE 5

| Lens | | | |
|---|---|---|---|
| number | Center thickness | Edge thickness | Deviation |
| L1 | 2.000 | 3.766 | −1.766 |
| L2 | 3.608 | 2.219 | 1.389 |
| L3 | 2.500 | 2.068 | 0.432 |
| L4 | 2.935 | 2.676 | 0.259 |
| L5 | 3.414 | 1.803 | 1.611 |
| L6 | 1.000 | 2.954 | −1.954 |
| L7 | 3.334 | 1.815 | 1.519 |
| L8 | 4.576 | 2.403 | 2.173 |

Referring to Table 5, the center thickness and the edge thickness of each of the lenses may be restricted to a specific range. In particular, the center thickness and the edge thickness of the sixth lens L6 may be restricted to a specific range. Thus, it is possible to reduce or equalize sensitivities when manufacturing the lenses, and improve a tolerance and performance.

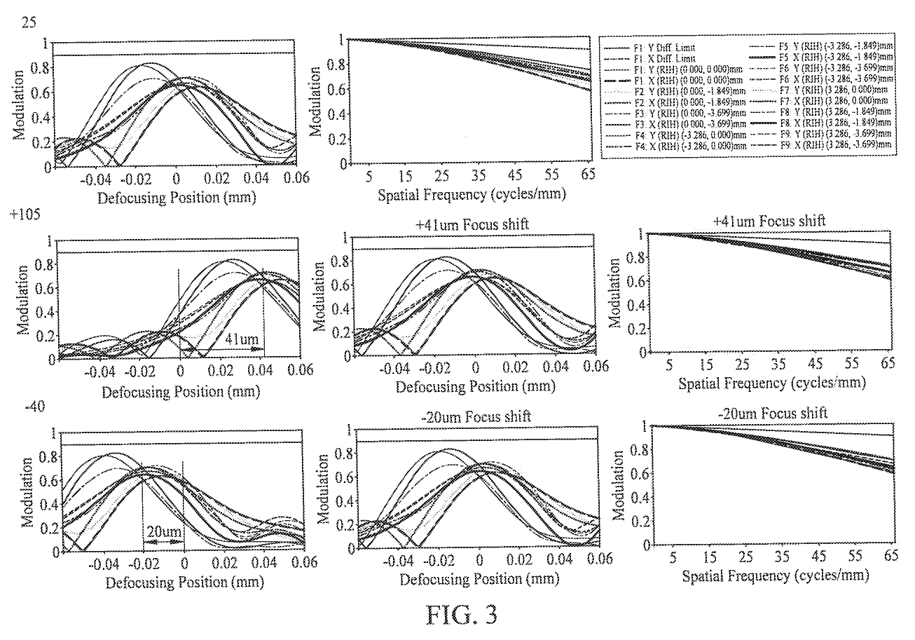

FIG. 3 illustrates modulation transfer function (MTF) graphs obtained from the example of FIG. 1. The graphs indicate a change in effective focal length at a high temperature and a low temperature. Referring to the graphs, it is verified that a variation in effective focal length of the first group and a variation in effective focal length of the second group may be inversely offset and a compensating relationship in terms of temperature is more explicitly established.

That is, according to an example embodiment, a change in overall effective focal length of the lens system occurring due to a temperature-based change in position and shape of internal elements or mechanical structures included in the lens system at a high temperature and a low temperature may be compensated for by a thermal property of a lens.

As described above, there is provided a head-up display lens system that satisfies a thermal compensation characteristic based on temperature by appropriately arranging or setting DN/DT values based on a refractive power of each lens and controlling a variation in focal length of each lens.

In detail, there is provided a high-resolution and high-performance head-up display lens system that satisfies a thermal compensation characteristic and provides a stable image despite a change in temperature by setting a DN/DT value for a lens having a relatively high refractive power.

For example, the high-resolution and high-performance head-up display lens system may be designed to include a lens array including a total of eight lenses as illustrated. The lens system may satisfy a thermal compensation characteristic and provide a stable image despite a change in temperature by setting a DN/DT value for a lens having a relatively high refractive power, for example, a fifth lens, a sixth lens, and an eighth lens as illustrated.

In detail, the high-resolution and high-performance head-up display lens system may be designed to be compact in size and lightweight in volume as described herein. The lens system may compensate for a resolution degradation by appropriately distributing refractive powers of lenses included in the lens system, setting a shape of each of the lenses, for example, a concave shape, a convex shape, and a meniscus shape, using a glass material insensitive to a change in temperature, selecting a material having a negative or positive DN/DT value, disposing each lens at an appropriate position in the lens array, and allowing a focal length to change when a refractive index changes by heat and a set position of a lens also changes by heat.

Thus, the head-up display lens system may establish an effective temperature compensating relationship between a first group of lenses and a second group of lenses in an environment, for example, at a high temperature, by setting a position of a diaphragm, appropriately distributing refractive powers of the first group of lenses and the second group of lenses based on the position of the diaphragm, setting a material for each of the lenses included in the first group and the second group, and appropriately designing an effective focal length of each of the lenses included in the first group and the second group.

1. A lens system for a head-up display, comprising:
a first group of lenses arranged towards a screen from a diaphragm; and
a second group of lenses arranged towards an image element,
wherein each of the lenses included in the first group and the second group is arranged such that a lens among the lenses that satisfies |P|=40, wherein P denotes a refractive power of each of the lenses, has a positive or negative DN/DT (abs.) (temperature coefficients of refractive index [10⁻⁶/° C. at 632.8 nm]) value based on the refractive power, and the lens system is configured to control a variation in focal length of each of the lenses to have a thermal compensation characteristic.

2. The lens system of claim 1, wherein a first lens, a second lens, a third lens, and a fourth lens of the first group are arranged from the screen along an optical axis, and
a fifth lens, a sixth lens, a seventh lens, and an eighth lens of the second group are arranged from the screen along the optical axis,
wherein the third lens, the fifth lens, the seventh lens, and the eighth lens have a positive refractive power, and
the fifth lens, the seventh lens, and the eighth lens have a refractive power greater than a refractive power of the third lens, and the fifth lens, the seventh lens, and the eighth lens have a negative DN/DT (abs.) value.

3. The lens system of claim 2, wherein the fifth lens, the seventh lens, and the eighth lens have a negative DN/DT (abs.) value in a temperature range from 60° C. to 80° C.

4. The lens system of claim 2 wherein, in a temperature range from −40° C. to −20° C., the fifth lens is selected from a group of materials having a DN/DT (abs.) value of −7.7 to −7.1, the seventh lens is selected from a group of materials having a DN/DT (abs.) value of −7.7 to −7.1, and the eighth lens is selected from a group of materials having a DN/DT (abs.) value of −4.9 to −4.3, or
in the temperature range from 60° C. to 80° C., the fifth lens is selected from a group of materials having a DN/DT (abs.) value of −7.3 to −6.7, the seventh lens is selected from a group of materials having a DN/DT (abs.) value of −7.3 to −6.7, and the eighth lens is selected from a group of materials having a DN/DT (abs.) value of −3.9 to −3.3.

5. The lens system of claim 2, wherein each of the fifth lens, the seventh lens, and the eighth lens satisfies 40.00<P<70.00, wherein P denotes a refractive power.

6. The lens system of claim 2, configured to satisfy −3.5<f1/f2<0, wherein f1 denotes an effective focal length of the first group, and f2 denotes an effective focal length of the second group.

7. The lens system of claim 2, configured to satisfy f2/F>1.1, wherein f2 denotes an effective focal length of the second group, and F denotes an overall effective focal length of the lens system.

8. A lens system for a head-up display, comprising:
a first group of lenses arranged towards a screen from a diaphragm; and
a second group of lenses arranged towards an image element,
wherein a first lens, a second lens, a third lens, and a fourth lens of the first group are arranged from the screen along an optical axis, and a fifth lens, a sixth lens, a seventh lens, and an eighth lens of the second group are arranged from the screen along the optical axis,
wherein the third lens, the fifth lens, the seventh lens, and the eighth lens have a positive refractive power,
the fifth lens, the seventh lens, and the eighth lens have a refractive power greater than a refractive power of the third lens, and
each of the fifth lens, the seventh lens, and the eighth lens satisfies 40.00<P<70.00, wherein P denotes a refractive power,
the fifth lens, the seventh lens, and the eighth lens have a negative DN/DT (abs.) (temperature coefficients of refractive index [10⁻⁶/° C. at 632.8 nm]) value at a high temperature (60° C. to 80° C.), and
the first through eighth lenses are formed of a glass material.

9. The lens system of claim 3 wherein, in a temperature range from −40° C. to −20° C., the fifth lens is selected from a group of materials having a DN/DT (abs.) value of −7.7 to −7.1, the seventh lens is selected from a group of materials having a DN/DT (abs.) value of −7.7 to −7.1, and the eighth lens is selected from a group of materials having a DN/DT (abs.) value of −4.9 to −4.3, or in the temperature range from 60° C. to 80° C., the fifth lens is selected from a group of materials having a DN/DT (abs.) value of −7.3 to −6.7, the seventh lens is selected from a group of materials having a DN/DT (abs.) value of −7.3 to −6.7, and the eighth lens is selected from a group of materials having a DN/DT (abs.) value of −3.9 to −3.3.
